(19) United States
(12) Patent Application Publication
(10) Pub. No.: US 2019/0007573 A1
(43) Pub. Date: Jan. 3, 2019

(54) IMAGE READING DEVICE, IMAGE READING METHOD, AND STORAGE MEDIUM

(71) Applicant: CANON KABUSHIKI KAISHA, Tokyo (JP)

(72) Inventor: Akitoshi Kikuchi, Ichikawa-shi (JP)

(21) Appl. No.: 16/007,034

(22) Filed: Jun. 13, 2018

(30) Foreign Application Priority Data
Jul. 3, 2017 (JP) 2017-130423

(51) Int. Cl. H04N 1/00; H04N 1/40

(52) U.S. Cl. CPC H04N 1/00835; H04N 1/40068; H04N 1/00997

(57) ABSTRACT

An image reading device according to an aspect of this invention is equipped with an image sensor having multiple sensor IC chips. The image reading device includes a detection unit which detects respective offset levels of a reference channel and of a correction target channel from among multiple channels provided for groups of the multiple IC chips, an acquisition unit which acquires a difference between the offset levels of the reference channel and of the correction target channel, and a correction unit which corrects shading data of a correction target sensor IC chip on the correction target channel based on the acquired difference.

### BACKGROUND OF THE INVENTION

### Field of the Invention

The present invention relates to an image reading device to read an image, an image reading method, and a storage medium.

### Description of the Related Art

There has heretofore been known an image reading device including a contact image sensor formed by arranging multiple sensor IC chips. In this image reading device, shading correction is executed by correcting offset levels in order to reduce a variation in output level among output signals from the respective sensor IC chips. Execution of the shading correction makes it possible to reduce a difference in density on a read image, which occurs due to the difference in output level among the respective IC chips.

For example, Japanese Patent Laid-Open No. 2011-97528 discloses an image reading device, in which each of sensor IC chips is provided with a circuit for correcting an offset level in order to reduce a variation with time and a variation in output level attributable to individual differences, which may appear among all the sensor IC chips.

### SUMMARY OF THE INVENTION

In such an image reading device, only a specific sensor IC chip may be affected by a specific heat source, and a variation in output level may occur as a consequence. For example, a surface-mounted LED serving as a light source inside an image sensor unit may be located near a specific sensor IC chip and may possibly affect only the specific sensor IC chip. In this case, therefore, the image reading device disclosed in Japanese Patent Laid-Open No. 2011-97528 may end up in having a number of unnecessary circuits. In other words, a circuit size of the image reading device may become too large.

The present invention has been made in view of the aforementioned problem and an object thereof is to provide an image reading device, an image reading method, and a storage medium, which are capable of performing shading correction while correcting an offset level of a specific sensor IC chip with a smaller circuit size.

An image reading device according to one embodiment of the present invention is an image reading device equipped with an image sensor having multiple sensor IC chips. The image reading device includes a detection unit which detects respective offset levels of a reference channel and of a correction target channel from among multiple channels provided for groups of the multiple IC chips, an acquisition unit which acquires a difference between the offset levels of the reference channel and of the correction target channel, and a correction unit which corrects shading data of a correction target sensor IC chip on the correction target channel based on the acquired difference.

Further features of the present invention will become apparent from the following description of exemplary embodiments with reference to the attached drawings.

### BRIEF DESCRIPTION OF THE DRAWINGS

FIG. 1 is a block diagram showing a configuration of an image reading device according to an embodiment of the present invention;

FIG. 2 is a cross-sectional view of an image sensor unit according to the embodiment of the present invention;

FIG. 3 is a diagram showing an example of analog outputs from the image sensor unit according to the embodiment of the present invention;

FIG. 4 is a graph showing an example of changes in offset voltage with time of respective channels in the image reading device according to the embodiment of the present invention;

FIG. 5 is a flowchart of image reading processing in the embodiment of the present invention; and

FIG. 6 is a flowchart of image reading processing in another embodiment of the present invention.

### DESCRIPTION OF THE EMBODIMENTS

Embodiments of the present invention will be described below in detail with reference to the drawings. Note that the same reference numerals appearing in different drawings represent the same constituents, respectively.

### First Embodiment

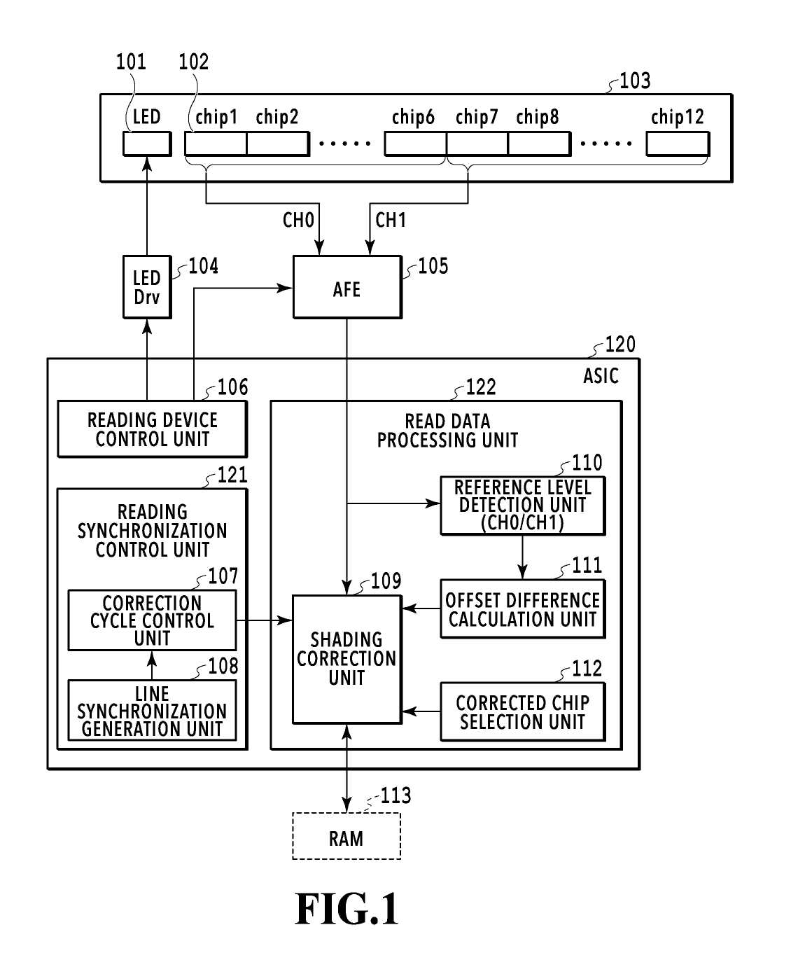

FIG. 1 is a block diagram showing a configuration of an image reading device of this embodiment. The image reading device can read an image on a document as a reading target by moving an image sensor unit 103 relative to the document while using a not-illustrated motor as a driving source.

The image sensor unit 103 includes an LED light source 101 and multiple sensor IC chips 102. The LED light source 101 is a light source provided inside the image sensor unit 103 and is located near a chip 1. The multiple sensor IC chips 102 are arranged in a line, thus constituting a linear image sensor formed from CCDs (charge-coupled devices) to output RGB analog signals and from light receiving pixels such as CIS's (contact image sensors) and configured to perform photoelectric conversion of reflected light from the document.

An LED driver 104 is a driving circuit for the LED light source 101.

An AFE (analog front end) device 105 receives analog signals from the multiple sensor IC chips 102 through data transfer analog channels CH0 and CH1 provided for groups of the sensor IC chips 102, respectively, and performs A/D conversion of the analog signals into digital signals. The digital signals obtained by the A/D conversion are forwarded to an ASIC 120. The AFE device 105 in this embodiment receives the analog signals from chips 1 to 6 through the analog channel CH0 and receives the analog signals from chips 7 to 12 through the analog channel CH1. In the meantime, although the multiple sensor IC chips 102 are divided into two groups in this embodiment, the division number is not limited to the foregoing and the sensor IC chips may be divided into three or more groups each provided with the corresponding analog channel.

The ASIC 120 includes a reading device control unit 106, a reading synchronization control unit 121, and a read data processing unit 122.

The reading device control unit 106 outputs control signals to the sensor IC chips 102 constituting a reading device, the AFE device 105, and the LED driver 104. The reading device control unit 106 receives the RGB analog signals from the sensor IC chips 102 in the form of the digital signals via the AFE device 105, and forwards the digital signals to the read data processing unit 122. The read data processing unit 122 performs sorting, packing, and so forth of image data based on the received digital signals. Moreover, the reading device control unit 106 performs light adjustment control of the LED light source 101 as well as feedback control and the like based on the inputted image signals.

The reading synchronization control unit 121 includes a correction cycle control unit 107 and a line synchronization generation unit 108.

The line synchronization generation unit 108 generates reading line synchronization signals. The correction cycle control unit 107 outputs correction cycle information on execution of correction processing and a trigger signal to the read data processing unit 122 in accordance with a predetermined time setting and the number of synchronization signals generated by the synchronization generation unit 108. In other words, the correction cycle control unit 107 controls a correction cycle to execute the shading correction. The correction cycle is set for each time interval stored in advance or for each predetermined number of lines in a vertical scanning direction. In the meantime, the correction cycle may vary depending on multiple reading modes with different resolutions, reading speeds, and the like. The reading mode is selected by a use at the start of scanning/copying processing.

The read data processing unit 122 includes a shading correction unit 109, a reference level detection unit 110, an offset difference calculation unit 111, and a corrected chip selection unit 112.

The reference level detection unit 110 detects and acquires data values of offset levels serving as reference for the respective channels such as the analog channels CH0 and CH1, and outputs the data values to the offset difference calculation unit 111. The offset difference calculation unit 111 calculates (acquires) a difference in offset level from the detected values of the respective offset levels (such as the offset levels of the analog channels CH0 and CH1) inputted thereto, then converts the difference into a correction value, and outputs the correction value to the shading correction unit 109. The corrected chip selection unit 112 outputs information (such as a chip number) for selecting a correction target sensor IC chip to the shading correction unit 109.

The shading correction unit 109 corrects shading data in accordance with the correction cycle information and the trigger signal from the correction cycle control unit 107, the offset difference correction value from the offset difference calculation unit 111, and the sensor chip selection information from the corrected chip selection unit 112.

A RAM 113 is a memory for storing ordinary shading data and data used for correction. The RAM 113 can be formed from an SRAM or the like and provided as an embedded memory in the ASIC 120. Alternatively, the RAM 113 may be formed from a DRAM or the like and provided as an external memory.

Although the example of FIG. 1 illustrates the two analog channels CH0 and CH1, three or more channels may be provided instead. In this case, one or more channels may be defined as the reference or one or more channels may be selected as correction target channels. In a case where multiple channels are defined as the reference, an average value or a total value of the channels may be used therefor. Meanwhile, if multiple channels are targeted for correction, then the multiple channels and the multiple sensor IC chips 102 may be corrected simultaneously based on reference information on the one or more channels.

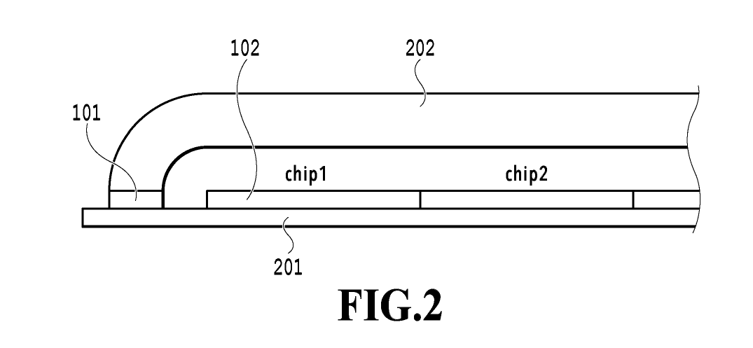

FIG. 2 is a cross-sectional view of the image sensor unit 103 of this embodiment. The LED light source 101 and the sensor IC chips 102 are mounted on the same board 201. Accordingly, the sensor IC chip 102 located near the LED light source 101 is susceptible to heat from the LED light source 101. In this case, a light guide body 202 takes the form of a twisted structure but has a cost advantage as a whole instead. Such a heat source is not limited to the LED light source 101 and other factors are also conceivable.

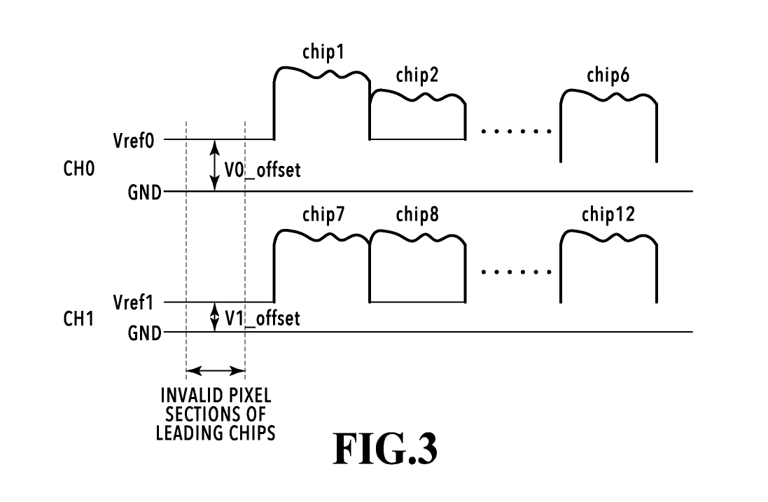

FIG. 3 is a diagram showing an example of analog outputs from the image sensor unit 103 of this embodiment.

FIG. 3 illustrates the case applicable to the configuration of the image sensor of FIG. 1, in which the chip (i.e., the chip 1 on the channel CH0) located near the LED light source 101 causes an increase in offset output (V0_offset) by a heat effect, for example. On the other hand, a chip (i.e., the chip 7 on the channel CH1) located far from the LED light source 101 and barely affected by the LED light source 101 as the heat source does not show an increase in offset output (V1_offset). Therefore, offset output levels are acquired by use of invalid pixel sections of leading chips (i.e., the chip 1 and the chip 7). In this embodiment, the offset output (V1_offset) of the channel CH1 is defined as a reference in order to calculate (acquire) the difference from the offset output (V0_offset) of the channel CH0 as the correction target, and the offset level of the channel CH0 is thus corrected.

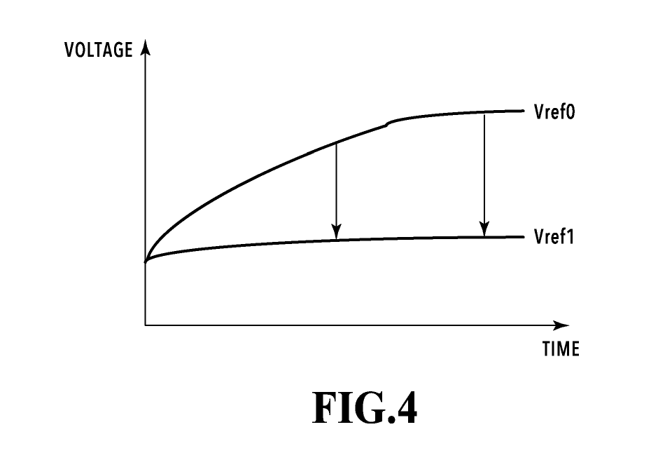

FIG. 4 is a graph showing an example of changes in offset voltage with time of the respective channels in the image reading device of this embodiment.

FIG. 4 depicts an offset voltage Vref0 of the channel CH0, an offset voltage Vref1 of the channel CH1, and a difference therebetween in the example of the analog outputs of FIG. 3. In a case where the offset voltage Vref0 of the channel CH0 is significantly affected by an external factor, the offset voltage Vref1 of the channel CH0 that is either affected less or not affected at all serves as the reference. A difference in offset output (Vref0−Vref1) is also increased with a lapse of time. In a case where the difference in offset output is increased in excess of a predetermined threshold, the channel CH0 significantly affected by the external factor is corrected by using the difference in offset output. Thus, it is possible to correct only the external factor that causes the difference between the channel CH0 and the channel CH1.

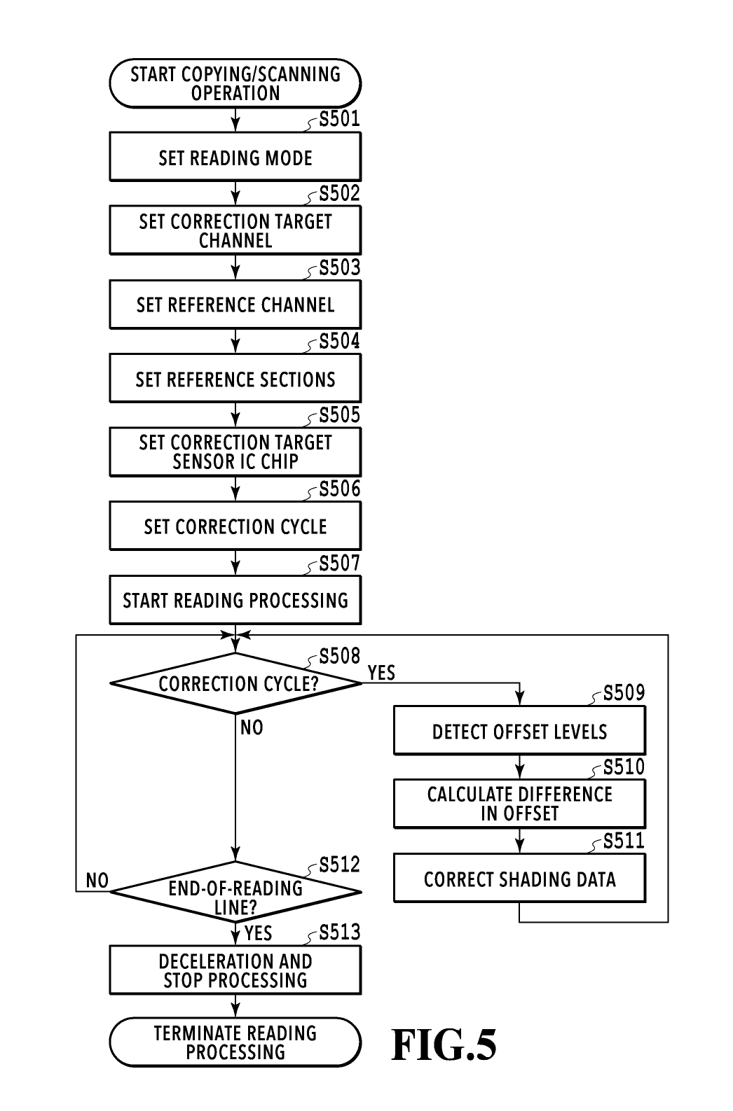

FIG. 5 is a flowchart of image reading processing in this embodiment. This image reading processing is carried out by the image reading device starting a copying or scanning operation in response to operation of an operation key by the user.

At step S501, the image reading device sets a reading mode selected by the user and applicable to the scanning/copying operation. The reading mode is selected from the multiple reading modes with different resolutions and reading speeds.

At step S502, the image reading device sets a correction target channel. In this embodiment, the channel CH0 including the chip 1 being a correction target sensor IC chip is set as the correction target channel.

At step S503, the image reading device sets a reference channel. In this embodiment, the channel CH1 is set as the reference channel.

At step S504, the image reading device sets reference sections for acquiring the offset levels of the respective channels. The reference sections are the invalid pixel sections of the leading chips on the respective channels.

At step S505, the image reading device sets the correction target sensor IC chip. The specific correction target sensor IC chip located near the LED light source 101 and liable to a more significant variation in offset level is set as the correction target sensor IC chip. In other words, among the multiple sensor IC chips, the sensor IC chip located at a position close to the LED light source 101 is targeted for the correction.

At step S506, the image reading device sets the correction cycle to perform the correction. The correction cycle is set for each time interval stored in advance or for each predetermined number of lines in the vertical scanning direction. Meanwhile, the correction cycle may vary depending on the multiple reading modes with the different resolutions, reading speeds, and the like.

At step S507, the image reading device performs settings necessary for the correction, and then starts the reading processing of the document.

At step S508, the image reading device determines whether or not the set correction cycle is applicable. The processing proceeds to step S509 in a case where the set correction cycle is applicable.

At step S509, the image reading device detects and acquires the respective offset levels of the analog outputs from the reference channel and the correction target channel.

At step S510, the image reading device calculates (acquires) the difference between the acquired offset levels of the reference channel and the correction target channel.

At step S511, the image reading device corrects the shading data for the correction target sensor IC chip on the correction target channel based on the calculated (acquired) difference.

Subsequently, the processing returns to step S508. The image reading device repeats the processing at steps S509 to S511 in a case where the set correction cycle is applicable. On the other hand, the processing proceeds to step S512 in a case where it is determined that the set correction cycle is not applicable.

At step S512, the image reading device determines whether or not the image reading device reaches an end-of-reading line on the document. In a case where the image reading device is yet to reach the end-of-reading line, the processing returns to step S508. On the other hand, the processing proceeds to step S513 in a case where the image reading device reaches the end-of-reading line.

At step S513, the image reading device performs deceleration and stop processing of the image sensor unit 103 as needed, and terminates the reading processing.

As described above, this embodiment performs the correction of the shading data by correcting the offset level of the specific sensor IC chip at the set correction cycle based on the information on the difference in offset level between the reference channel and the correction target channel of the image sensor. In this way, it is possible to deal with the environment where the specific sensor IC chip, which is exposed to the more significant effect of the specific heat source such as the LED light source, provides a significant effect on the output levels of the entire image sensor. Moreover, since this embodiment does not require many correction circuits, it is possible to correct the shading data by correcting the offset level of the specific sensor IC chip with a smaller circuit size.

Further, since this embodiment conducts the correction of the shading data while detecting the amount of correction in the course of the reading operation in accordance with the set correction cycle, it is possible to achieve the optimized correction in each reading mode.

Further, the image reading device of this embodiment can also be mounted on a discrete scanner or an MFP (multi-function printer) equipped with a scanner. Here, the similar effect can be achieved in each case.

### Second Embodiment

In the above-described first embodiment, the settings necessary for the shading correction are set before starting the reading processing at step S507 as illustrated in the flowchart of FIG. 5. Meanwhile, in this embodiment, the settings necessary for the shading correction are re-set after starting the reading processing.

Note that a configuration of an image reading device of this embodiment is the same as the configuration of the image reading device of the first embodiment described with reference to FIG. 1.

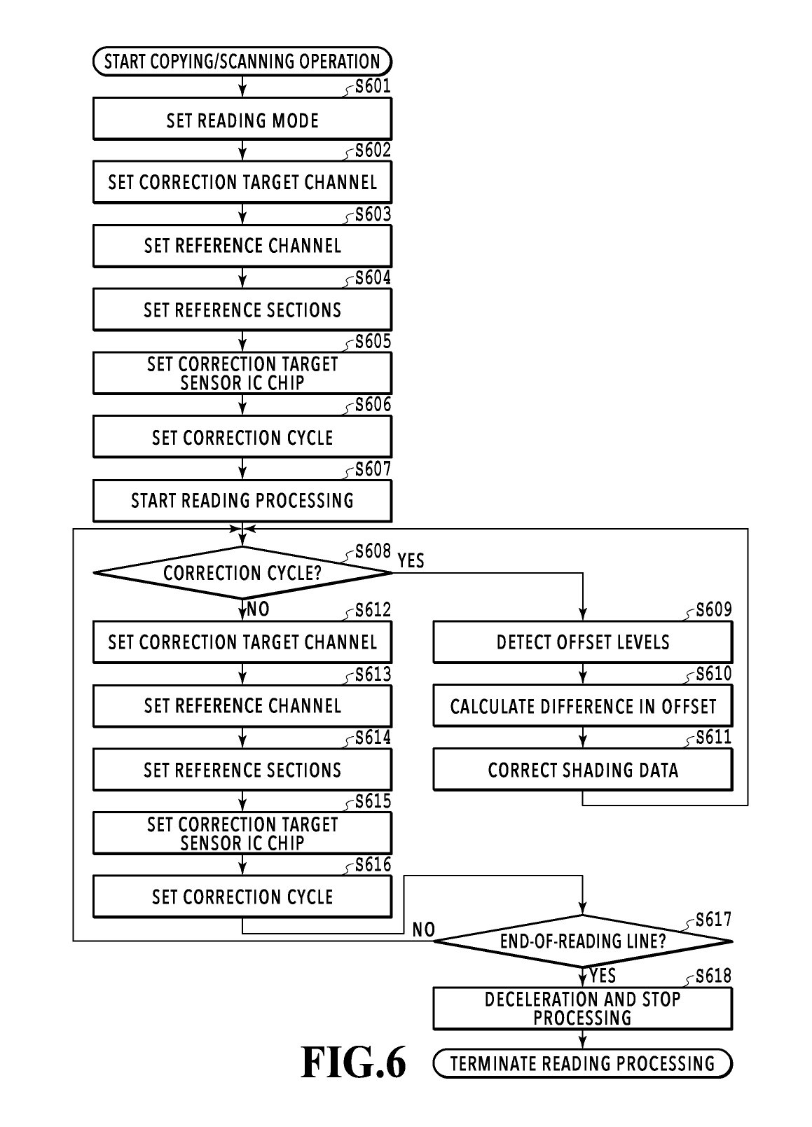

FIG. 6 is a flowchart of reading processing in this embodiment.

The description of the processing at steps S601 to S611, S617, and S618 of FIG. 6 will be omitted herein because these steps are the same as steps S501 to S513 of FIG. 5.

In this embodiment, in a case where it is determined that the set correction cycle is not applicable at step S608, the processing proceeds to steps S612 to S616 where the image reading device re-sets the settings necessary for the shading correction. The processing at steps S612 to S616 is the same as the processing at steps S602 to S606. Specifically, at steps S612 to S616, the image reading device re-sets the correction target channel, the reference channel, the reference sections, the correction target IC chip, and the correction cycle as needed. Here, only some of the aforementioned items may be re-set instead of re-setting all these items.

As described above, in this embodiment, the settings necessary for the shading correction are reset in each set correction cycle. In this way, it is possible to optimize the settings necessary for the shading correction during the reading operation in such a case where the reading processing takes a long time as a consequence of designation of a high-resolution reading mode, thus leading to a rise in the amount of change of the offset level.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to provide an image reading device, an image reading method, and a storage medium, which are capable of performing shading correction while correcting an offset level of a specific sensor IC chip with a smaller circuit size.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-130423 filed Jul. 3, 2017, which is hereby incorporated by reference wherein in its entirety.

What is claimed is:

1. An image reading device equipped with an image sensor having a plurality of sensor IC chips, comprising:
a detection unit configured to detect respective offset levels of a reference channel and of a correction target channel from among a plurality of channels provided for groups of the plurality of IC chips;
an acquisition unit configured to acquire a difference between the offset levels of the reference channel and of the correction target channel; and
a correction unit configured to correct shading data of a correction target sensor IC chip on the correction target channel based on the acquired difference.

2. The image reading device according to claim 1, wherein actions of the detection unit, the acquisition unit, and the correction unit are executed in each predetermined correction cycle during a reading operation.

3. The image reading device according to claim 2, wherein the predetermined correction cycle is any of a time interval stored in advance and a predetermined number of lines in a vertical scanning direction.

4. The image reading device according to claim 3, wherein the time interval stored in advance and the predetermined number of lines in the vertical scanning direction vary with a plurality of reading modes with different resolutions and different reading speeds.

5. The image reading device according to claim 1, wherein the correcting unit corrects the shading data by correcting an offset level of the correction target sensor IC chip in a case where the acquired difference is equal to or above a predetermined threshold.

6. The image reading device according to claim 1, wherein,
a first sensor IC chip from among the plurality of sensor IC chips is not set as the correction target sensor IC chip, and
a second sensor IC chip from among the plurality of sensor IC chips, which is located at a position closer to a specific heat source than the first sensor IC chip, is set as the correction target sensor IC chip.

7. The image reading device according to claim 6, wherein the specific heat source is an LED light source mounted on the image sensor.

8. An image reading method to be executed by an image reading device equipped with an image sensor having a plurality of sensor IC chips, the method comprising the steps of:
detecting respective offset levels of a reference channel and of a correction target channel from among a plurality of channels provided for groups of the plurality of sensor IC chips;
acquiring a difference between the offset levels of the reference channel and of the correction target channel; and
correcting shading data of a correction target sensor IC chip on the correction target channel based on the acquired difference.

9. A non-transitory computer readable storage medium storing a program for causing a computer to perform an image reading method, the method comprising the steps of:
detecting respective offset levels of a reference channel and of a correction target channel from among a plurality of channels provided for groups of a plurality of sensor IC chips included in an image sensor;
acquiring a difference between the offset levels of the reference channel and of the correction target channel; and
correcting shading data of a correction target sensor IC chip on the correction target channel based on the acquired difference.
